(19) United States
(12) Patent Application Publication
(10) Pub. No.: US 2008/0053448 A1
(43) Pub. Date: Mar. 6, 2008

(54) Nasal filter

(76) Inventor: Regina B. Liska, Apopka, FL (US)

Correspondence Address: P. JEFF MARTIN;SUITE 200, 2120 SEA MOUNTAIN HWY, P.O. BOX 4369, N. MYRTLE BEACH, SC, 29597, US

(21) Appl. No.: 11/513,966

(22) Filed: Aug. 31, 2006

(51) Int. Cl. A62B 23/02; A62B 7/10

(52) U.S. Cl. 128/206.11; 128/205.29

(57) ABSTRACT

An improved nasal filter is provided which includes a pair of filter housings joined by a flexible bridge. The bridge is adapted to conform and removably adhere to the outer contour of the nasal columella or nose tip of a user's nose. The filter housings are oval-shaped and include a filter-insert cavity. The filter-insert cavity is adapted to receive and removably hold a disposable filter element therein. The filter housings are formed of a soft, shape-memory material adapted to flexibly accommodate the anatomy of the internal nasal passages of a nose. The improved nasal filter is adapted to improve the quality of air inhaled by individuals while providing a comfortable, quick, easy, and efficient customized fit.

### RELATED APPLICATIONS

The present invention was first described in Disclosure Document No. 603,061 filed on Jul. 3, 2006 under 35 U.S.C. §122, 37 C.F.R. §1.14, and MPEP §1706. There are no previously filed, nor currently any co-pending applications, anywhere in the world.

### BACKGROUND OF THE INVENTION

1. Field of the Invention

The present invention relates generally to filters and, more particularly, to an improved, custom-fit nasal filter.

2. Description of the Related Art

The human body is penetrated by many airborne contaminants and pollutants. Millions of people across the globe are afflicted by upper respiratory symptoms which typically stem from allergic reactions to the airborne pollutants.

As a result, a variety of nasal filters to filter incoming air as well as air purifiers have been developed over the years. These nasal filter devices include the nasal-insertion type as well as devices incorporating clamps or clips for being clipped to the septum portion of the nose. However, none of these devices are adapted to accommodate a variety of different-sized noses in a manner which provides a “custom-fit.”

Accordingly, a need has arisen for an improved, custom-fit nasal filter adapted to capture aeroallergens, dust, pollen, animal dander, construction dusts, contagious contaminants, and other environmental pollutants, particulates, and airborne impurities in a manner which is quick, easy, and efficient. The development of the improved nasal filter fulfills this need.

A search of the prior art did not disclose any patents that read directly on the claims of the instant invention; however, the following references were considered related.

The following patents disclose various nasal filter devices:

U.S. Pat. No. 4,030,491, issued in the name of Mattila;

U.S. Pat. No. 4,401,117, issued in the name of Gershuny;

U.S. Pat. No. 5,636,629, issued in the name of Patterson, Jr.;

U.S. Pat. No. 3,722,509, issued in the name of Nebel;

U.S. Pat. No. 6,981,501 B2, issued in the name of Michaels;

U.S. Pat. No. 3,802,426, issued in the name of Sakamoto;

U.S. Pat. No. 6,701,924 B1, issued in the name of Land, Jr. et al.; and

U.S. Pat. No. 6,109,262, issued in the name of Tovey.

U.S. Pat. No. 6,015,425, issued in the name of Altadonna, Jr. discloses an odor-desensitizing intra-nasal clip for dental patients, which can be inserted into the nasal passages.

Consequently, a need has been felt for an improved, custom-fit nasal filter adapted to capture aeroallergens, dust, pollen, animal dander, construction dusts, contagious contaminants, and other environmental pollutants, particulates, and airborne impurities in a manner which is quick, easy, and efficient.

### SUMMARY OF THE INVENTION

Therefore, it is an object of the present invention to provide a unique, custom-fit nasal filter.

It is another object of the present invention to provide a nasal filter adapted to capture aeroallergens, dust, pollen, animal dander, construction dusts, contagious contaminants, and other environmental pollutants, particulates, and airborne impurities.

It is another object of the present invention to provide a nasal filter having a filter element impregnated with various aromas, pleasant-smelling odorants or fragrance agents, medicaments, or therapeutic agents.

It is another object of the present invention to provide a nasal filter having a pair of filter housings joined by a flexible bridge adapted to flexibly conform and removably adhere via adsorption to an outer contour and configuration of the nasal columella or nose tip of a nose.

It is another object of the present invention to provide an alternate nasal filter embodiment which includes a prolate-shaped retainer centrally enveloped within a pad, wherein retainer is adapted to bend to a curvature and hold such curvature.

Briefly described according to one embodiment of the present invention, an improved nasal filter is disclosed. The nasal filter is adapted to improve the quality of air inhaled by individuals while providing a comfortable, quick, easy, and efficient customized fit. Particularly, the nasal filter is adapted to capture aeroallergens, dust, pollen, animal dander, construction dusts, contagious contaminants, and other environmental pollutants, particulates, and airborne impurities.

The nasal filter is comprised of a pair of filter housings joined by a flexible bridge. The bridge is adapted to flexibly conform and removably adhere via adsorption to an outer contour and configuration of the nasal columella or nose tip of a nose. The filter housings are defined generally as having a semi-cylindrical or oval configuration with a filter-insert cavity. The filter-insert cavity is adapted to receive and removably hold a disposable filter element therein. The filter housings are formed of a soft, flexible, shape-memory plastic or polymeric material adapted to flexibly accommodate the anatomy of the internal nasal passages of a nose.

The filter element is of the disposable-type and is fabricated of a porous, absorbent, perforate, lightweight, non-allergenic, fibrous material. The filter element is easily replaceable. The filter element is adapted to be impregnated with various aromas, pleasant-smelling odorants or fragrance agents, medicaments, or therapeutic agents.

The use of the present invention provides an improved, custom-fit nasal filter adapted to capture aeroallergens, dust, pollen, animal dander, construction dusts, contagious contaminants, and other environmental pollutants, particulates, and airborne impurities in a manner which is quick, easy, and efficient.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a perspective view of an improved nasal filter, according to the preferred embodiment of the present invention;

FIG. 2 is a perspective view thereof illustrating the annular lip and posterior end of the filter housings;

FIG. 3 is a front perspective view of a nose;

FIG. 4 is a cross-sectional view of the nose;

FIG. 5 is a cross-sectional view of the filter housing illustrating the recess thereof, according to the preferred embodiment of the present invention;

FIG. 6 is a cross-sectional view of the filter housing having a filter element housed therein, according to the preferred embodiment of the present invention;

FIG. 7 is a side elevational view of the filter element, according to the preferred embodiment of the present invention;

FIG. 8 is a top plan view illustrating a plurality of various filter elements, according to the preferred embodiment of the present invention;

FIG. 9 is a top perspective view of the improved nasal filter illustrating filter elements housed within filter housings, according to the preferred embodiment of the present invention;

FIG. 10 is a top perspective view illustrating the peripheral edge, narrow width, and central broad width portions of the membrane, according to the preferred embodiment of the present invention;

FIG. 11 illustrates an alternate embodiment of the bridge;

FIG. 12 is a top perspective view illustrating the elongated pad of the alternate embodiment;

FIG. 13 illustrates an acrylic adhesive carrier provided along the lower surface area of the pad; and

FIG. 14 is a perspective view of the present invention shown in-use.

### DESCRIPTION OF THE PREFERRED EMBODIMENT

### 1. Detailed Description of the Figures

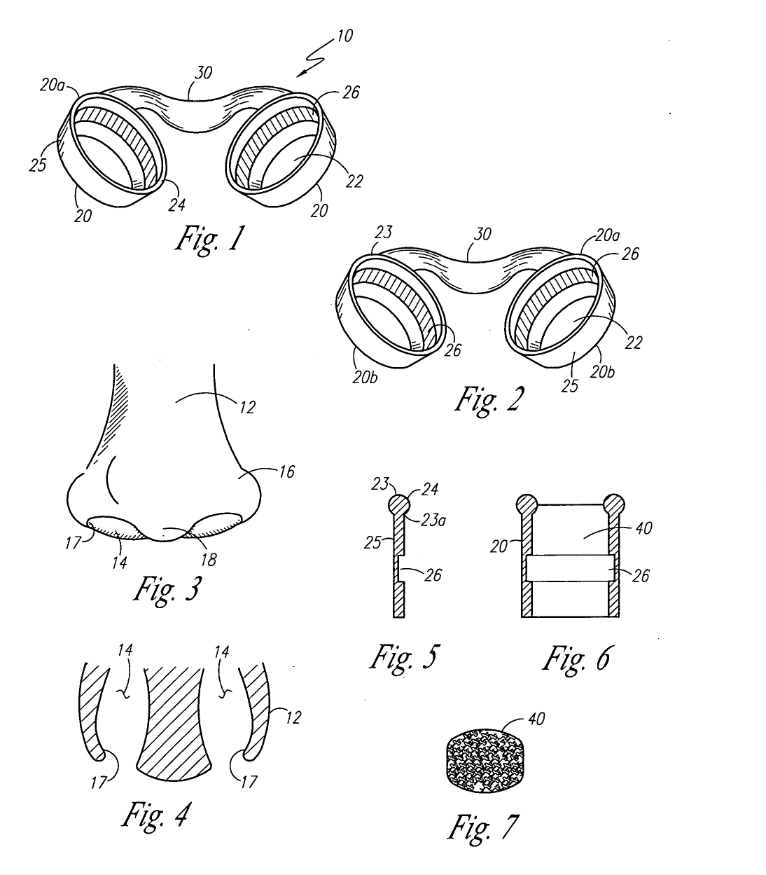

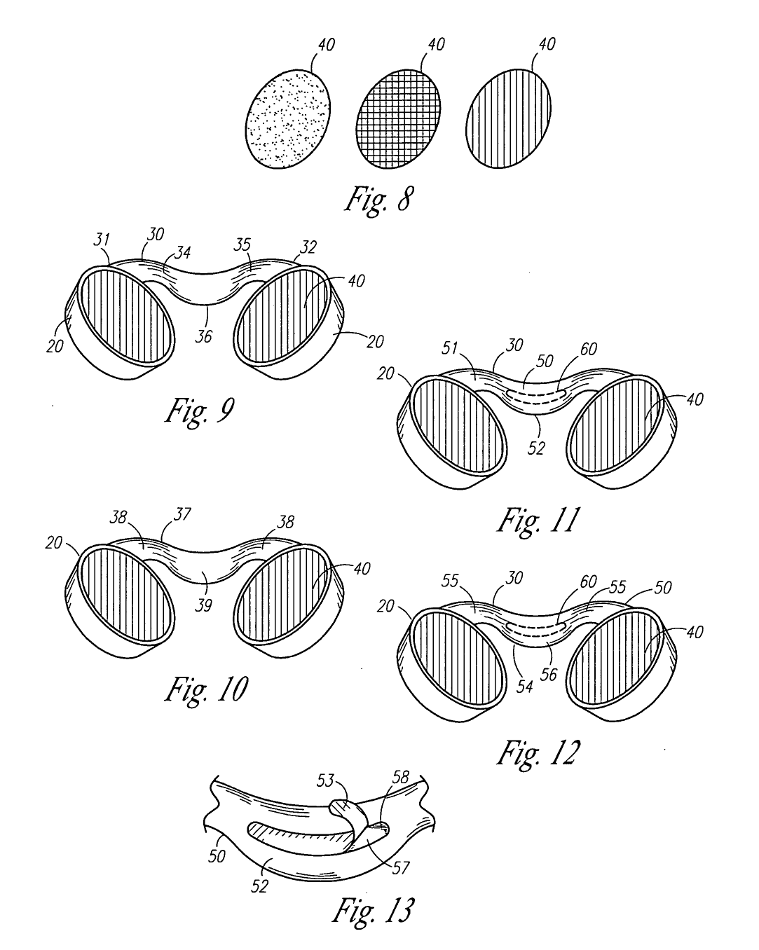

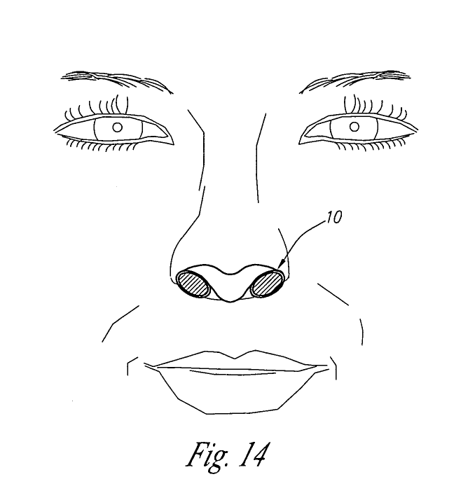

Referring now to FIGS. 1, 2, and 5-10, a new and improved nasal filter 10 is shown, according to the present invention, adapted for improving the quality of air inhaled by individuals while providing a comfortable, quick, easy, and efficient customized fit. Particularly, the improved nasal filter 10 is adapted to capture aeroallergens, dust, pollen, animal dander, construction dusts, contagious contaminants, and other environmental pollutants, particulates, and airborne impurities.

Referring more specifically to FIGS. 1-6, 11,12, and 14, the nasal filter 10 is comprised of a pair of filter housings 20 joined by a flexible bridge 30 (to be described later in greater detail). The filter housings 20 include an anterior end 20a opposing a posterior end 20b. The filter housings 20 are defined generally as having a semi-cylindrical or oval configuration with a filter-insert cavity 22. The filter-insert cavity 22 is adapted to receive and removably hold a disposable filter element 40 therein. The filter housings 20 are formed of a soft, flexible, shape-memory plastic or polymeric material adapted to flexibly accommodate the anatomy of the internal nasal passages 14 of a nose 12.

The anterior end 20a of filter housings 20 defines an annular, bulbous upper surface 24 from which an integral, continuous side wall 25 extends downwardly therefrom. The side wall 25 tapers slightly from the anterior end 20a at bulbous upper surface 24 of filter housings 20 to the posterior end 20b thereof. The bulbous upper surface 24 is oriented so as to protrude toward filter-insert cavity 22, thereby forming an annular lip 23 against which filter element 40 is buttressed. The integral side wall 25 includes a recess 26 encircling the inner surface thereof. The recess 26 is located generally medially with respect to side wall 25 interior.

The filter element 40 is inserted within the filter-insert cavity 22 of filter housings 20 in a manner such that an outer periphery of filter element 40 flexibly conforms and adapts to the contour of recess 26 and an upper surface of filter element 40 contacts an underside 23a of the annular lip 23, thereby snugly affixing filter element 40 within filter housings 20 until filter element 40 is desired to be removed by user.

The configuration of the anterior end 20a of filter housings 20 allows the annular lip 23 thereof to be placed within the nasal passages 14 just behind the narrowing of the nostril ala 17, or the flesh which surrounds the nostrils 16 away from the center of the nose 12. Thus, the configuration and the positioning of the filter housings 20 function to gently restrain the nasal filter 10 so as to prevent dislodgement during normal daily activities such as walking, talking, working, eating, drinking, and laughing.

The filter housings 20 are constructed of a soft, flexible plastic or polymeric material which includes silicone rubber, thermosensitive siliconised polyvinyl chloride, polyurethane, polyethylene, polystyrene, and polyethylene terephthalate. It is envisioned that filter housings 20 may also be manufactured of a flexible material which includes cardboard, a lightweight metal or metallic-plastic composite, such as gold, soft silver and plastic composites thereof.

Referring now to FIGS. 6-12, the filter element 40 is fabricated of a porous, absorbent, perforate, lightweight, non-allergenic, fibrous material and is easily replaceable. Fabrication materials are envisioned to include dense cotton felt, wool, woven and non-woven fibrous material, semi-rigid polyurethane foam, and reticulated foam produced from polyurethane or silicone, or from polyether, or polyester. The filter element 40 is adapted to collect and retain aeroallergens, dust, pollen, animal dander, construction dusts, contagious contaminants, and other environmental pollutants, particulates, and harmful airborne impurities. Filter element 40 is inserted into each of the filter housings 20 and filter housings 20 are prominently positioned within the air flow within internal nasal passages 14 of a nose 12 without significantly blocking air passage through the nasal passages 14.

The filter element 40 is adapted to be impregnated with various aromas, pleasant-smelling odorants or fragrance agents, medicaments, or therapeutic agents. For example, filter element 40 can be impregnated with oxymetazoline in order to treat nasal congestion. Additionally, filtering action of the filter element 40 can be enhanced by the use of an adsorbant material such as charcoal being dispersed therethrough.

In use, the improved nasal filter 10 provides protection for user's respiratory system against harmful impurities and pollutants in the air. In light of nasal filter's 10 filtering qualities and porous construction, the nasal filter 10 not only allows an individual to breathe clean air in a normal, unobstructed manner, but it also enhances user's overall health.

Referring specifically to FIGS. 1-3, 9, 10, and 14, the flexible bridge 30 affords important, additional novel utility as described hereinbelow. The bridge 30 includes opposing ends 31, 32 to which the pair of filter housings 20 integrally joins respectively. Alternatively, the pair of filter housings 20 are suitably attached to bridge 30 at opposing ends 31,32 thereof. Thus, in either configuration, the bridge 30 includes a filter housing 20 joined at each end 31, 32 thereof. The bridge 30 comprises an elongated membrane 34 defining an upper and lower surface area 35, 36 and a peripheral edge 37. The peripheral edge 37 of membrane 34 defines portions of narrow width, indicated at 38 and a central broad width at 39. The bridge 30 is further defined as a soft, flexible, elongated planar membrane 34 adapted to flexibly conform and removably adhere via adsorption to an outer contour and configuration of the nasal columella 18 or nose tip of a nose 12. The bridge 30 is configured and adapted to traverse the nasal columella 18 during application. More specifically, the bridge 30 is fabricated of a soft, flexible, polymer-based material adapted to stretch and conform to the outer configuration of the nasal columella 18 and retain such conformity so as to provide each individual user with a unique customized-fit. Once the bridge 30 is stretched to conform to the outer configuration of a particular user's nasal columella 18, bridge 30 undergoes slight contraction, thereby adhering to the nasal columella 18 or nose tip through adsorption. Therefore, after bridge 30 is distended to accommodate the contours of user's nasal columella 18, bridge 30 slightly contracts and maintains its configuration, thereby securing the bridge 30 and thus the improved nasal filter 10 to user's nose 12.

The soft, flexible, polymer-based material is defined as single-crystal silicon, however, other soft, flexible plastic or polymeric materials suitable for constructing bridge 30 include but are not limited to silicone rubber, thermosensitive siliconised polyvinyl chloride, polyurethane, polyethylene, polystyrene, and polyethylene terephthalate.

The bridge 30 is constructed so as to be available in a variety of colors, including skin tone or flesh-color, or transparent.

Referring now to FIGS. 11-13, an alternate embodiment of the bridge 30 is disclosed, wherein bridge 30 comprises an elongated flexible pad 50 defining an upper and lower surface area 51, 52 and a peripheral edge 54. The peripheral edge 54 of pad 50 defines portions of narrow width, indicated at 55 and a central broad width at 56.

An elongated, prolate-shaped retainer 60 is centrally enveloped in a generally horizontal arrangement within pad 50, occupying a substantial portion of the central broad width 56. The retainer 60 is constructed of a semi-flexible material adapted to bend to a shaped curvature and maintain the shaped curvature in its existing state. Thus, retainer 60 is adapted to be bent to a curvature and to hold such curvature until or unless user subsequently bends retainer 60 to form an alternative curvature or straightens retainer 60. In use, after carefully inserting filter housings 20 within the internal nasal passages 14, the lower surface area 52 of pad 50 is engaged against the nasal columella 18 of the nose 12, and retainer 60 is bent to a curvature defining the contour of user's nasal columella 18. Once retainer 60 has been forcibly re-shaped to accommodate the contours of user's nasal columella 18, retainer 60 maintains this configuration, thereby securing the pad 50 and thus the improved nasal filter 10 to user's nose 12.

The retainer 60 is constructed of a semi-flexible material which includes a plastic, plastic polymer, or a lightweight metal such as aluminum, or a metallic-plastic composite.

The lower surface area 52 of pad 50 may include an acrylic adhesive carrier 57 of about 0.0015 inch liner for die cutting is double-sided, adhesive-coated transparent polyethylene film, indicated by numeral 58. The acrylic adhesive carrier 57 is adapted to adhere to skin of the nose 12. The transparent polyethylene film is coated on both sides with a hypoallergenic, pressure-sensitive, acrylate adhesive, supplied on a releasable liner 53.

The pad 50 is constructed of a soft, flexible material which includes but is not limited to plastic, plastic polymer, or a textile. The pad 50 is constructed so as to be available in a variety of colors, including skin tone or flesh-color, or transparent.

The improved nasal filter 10 is adapted to accommodate noses 12 of various shapes and sizes.

### 2. Operation of the Preferred Embodiment

To use the present invention, user inserts a filter element 40 in each filter housing 20. Next, user carefully inserts the posterior end 20b of each filter housing 20 within the internal nasal passages 14 of user's nose 12 in such a manner that the annular lip 23 of filter housings 20 is placed within the nasal passages 14 just behind the narrowing of the nostril ala 17. User next engages the lower surface area 36 of bridge 30 against user's nasal columella 18, and slightly stretches the planar membrane 34 of bridge 30 to conform to the outer configuration of user's nasal columella 18, whereupon bridge 30 undergoes slight contraction, thereby adhering bridge 30 to user's nasal columella 18 through adsorption. Hence, after bridge 30 is distended to accommodate the contours of user's nasal columella 18, bridge 30 slightly contracts and maintains this configuration thereby securing bridge 30 and thus the improved nasal filter 10 to user's nose 12.

The use of the present invention provides an improved, custom-fit nasal filter adapted to capture aeroallergens, dust, pollen, animal dander, construction dusts, contagious contaminants, and other environmental pollutants, particulates, and airborne impurities in a manner which is quick, easy, and efficient.

Therefore, the foregoing description is included to illustrate the operation of the preferred embodiment and is not meant to limit the scope of the invention. As one can envision, an individual skilled in the relevant art, in conjunction with the present teachings, would be capable of incorporating many minor modifications that are anticipated within this disclosure. The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents. Therefore, the scope of the invention is to be broadly limited only by the following Claims.

What is claimed is:

1. A nasal filter comprising:
a pair of filter housings, said pair of filter housings is joined by a flexible bridge, said pair of filter housings is each defined generally as having a semi-cylindrical or oval configuration and having a filter-insert cavity, wherein each of said pair of filter housings includes an anterior end opposing a posterior end; and
a filter element, said filter element is adapted to be received and removably held within said filter-insert cavity of each said pair of filter housings, said filter element is disposable.

2. The nasal filter of claim 1, wherein said filter housings are constructed of a soft, flexible, shape-memory plastic or polymeric material adapted to flexibly accommodate an anatomy of internal nasal passages of a nose.

3. The nasal filter of claim 1, wherein said anterior end of said filter housings defines an annular, bulbous upper surface from which an integral, continuous side wall extends downwardly therefrom, said continuous side wall tapers slightly from said anterior end at said bulbous upper surface to said posterior end of said filter housings.

4. The nasal filter of claim 3, wherein said bulbous upper surface is oriented so as to protrude toward said filter-insert cavity, thereby forming an annular lip against which said filter element is buttressed, said continuous side wall includes a recess encircling an inner surface thereof, and wherein said recess is located generally medially with respect to said inner surface of said continuous side wall.

5. The nasal filter of claim 1, wherein said filter element filter element is fabricated of a porous, absorbent, perforate, lightweight, non-allergenic, fibrous material.

6. The nasal filter of claim 4, wherein said filter element is inserted within said filter-insert cavity of each said filter housings in a manner such that an outer periphery of said filter element flexibly conforms and adapts to a contour of said recess, and in a manner such that an upper surface of said filter element contacts an underside of said annular lip, thereby snugly affixing said filter element within said filter housings until said filter element is desired to be removed by user, and wherein configuration of said anterior end of said filter housings allows said annular lip to be placed within the internal nasal passages just behind a narrowing of a nostril ala of the nose without significantly blocking air passage through the internal nasal passages, and thereby preventing dislodgement of said filter housings during normal daily activities which include walking, talking, working, eating, drinking, and laughing.

7. The nasal filter of claim 5, wherein said filter element is adapted to collect and retain aeroallergens, dust, pollen, animal dander, construction dusts, contagious contaminants, and other environmental pollutants, particulates, and harmful airborne impurities.

8. The nasal filter of claim 5, wherein said filter element is impregnated with at least one absorbant which includes various aromas, pleasant-smelling odorants or fragrance agents, medicaments, or therapeutic agents.

9. The nasal filter of claim 5, wherein said filter element having an adsorbant material dispersed therethrough so as to enhance filtering action of said filter element.

10. The nasal filter of claim 1, wherein said bridge comprises opposing ends to which said pair of filter housings integrally joins, respectively, and wherein said bridge further comprises an elongated membrane defining an upper and lower surface area and a peripheral edge, said peripheral edge defines portions of narrow width and a central broad width.

11. The nasal filter of claim 10, wherein said elongated membrane is further defined as soft and flexible and having a planar configuration, said elongated membrane is adapted to flexibly conform and removably adhere via adsorption to an outer contour and configuration of a nasal columella of the nose, said elongated membrane is configured and adapted to traverse the nasal columella during application of the nasal filter, and wherein said elongated membrane is adapted to stretch and conform to the outer contour and configuration of the nasal columella and to thereafter undergo slight contraction in a manner such that said elongated membrane adheres to the nasal columella through adsorption, and thereby providing each individual user with a unique customized-fit.

12. The nasal filter of claim 10, wherein said elongated membrane is constructed of a soft, flexible, polymer-based material.

13. The nasal filter of claim 11, wherein said soft, flexible, polymer-based material includes silicone rubber, thermosensitive siliconised polyvinyl chloride, polyurethane, polyethylene, polystyrene, and polyethylene terephthalate.

14. The nasal filter of claim 11, wherein said soft, flexible, polymer-based material is single-crystal silicon.

15. The nasal filter of claim 10, wherein said bridge is constructed so as to be available in a variety of colors, including skin tone or flesh-color, or transparent.

16. The nasal filter of claim 8, wherein said absorbant is oxymetazoline.

17. A nasal filter comprising:
a pair of filter housings, said pair of filter housings is joined by a flexible bridge, said pair of filter housings is each defined generally as having a semi-cylindrical or oval configuration and having a filter-insert cavity, wherein each of said pair of filter housings includes an anterior end opposing a posterior end, each of said pair filter housings is constructed of a soft, flexible, shape-memory plastic or polymeric material adapted to flexibly accommodate an anatomy of internal nasal passages of a nose, said bridge comprises an elongated flexible pad defining an upper and lower surface area and a peripheral edge, said peripheral edge of said pad defines portions of narrow width and a central broad width;
a retainer, said retainer defines an elongated, prolate-shaped configuration, said retainer is centrally enveloped in a generally horizontal arrangement within said flexible pad, said retainer occupies a substantial portion of said central broad width; and
a filter element, said filter element is adapted to be received and removably held within said filter-insert cavity of each said pair of filter housings, said filter element is disposable.

18. The nasal filter of claim 17, wherein said retainer is constructed of a semi-flexible material adapted to bend to a shaped curvature and maintain the shaped curvature in its existing state.

19. The nasal filter of claim 17, wherein said lower surface area of said flexible pad is adapted for engagement against a nasal columella of a nose, said retainer is adapted to bend to a curvature defining a contour of the nasal columella, said retainer maintains the curvature, thereby securing said flexible pad and thus the nasal filter to the nose.

20. The nasal filter of claim 17, wherein said lower surface area of pad includes an acrylic adhesive carrier of about 0.0015 inch liner for die cutting is double-sided, adhesive-coated transparent film, said acrylic adhesive carrier is adapted to adhere to skin of the nose, said transparent film is coated on both sides with a hypoallergenic, pressure-sensitive, acrylate adhesive, supplied on a releasable liner.
